(19) United States
(12) Patent Application Publication
(10) Pub. No.: US 2009/0051273 A1
(43) Pub. Date: Feb. 26, 2009

(54) Organic Electroluminescence Element, Image Display Device and Lighting Device

(75) Inventors: Aki Tsuji, Kyoto (JP); Tomoyuki Nakayama, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 11/817,133

(22) PCT Filed: Feb. 23, 2006
(86) PCT No.: PCT/JP2006/303224

§ 371 Date: Aug. 24, 2007

(30) Foreign Application Priority Data
Mar. 2, 2005 (JP) 2005057050

(51) Int. Cl. H01J 1/62

(52) U.S. Cl. 313/504

(57) ABSTRACT

In an organic electroluminescence element incorporating a substrate having thereon an anode, a cathode, and an emission unit between the anode and the cathode, the organic electroluminescence element is characterized by having a structure in which the emission unit incorporates at least three emission layers, provided that at least two of the emission layers have different emission peaks, and among the emission layers incorporated in the emission unit, the emission layer having a shortest wavelength emission peak is sandwiched between the emission layers each having a longer wavelength emission peak.

### TECHNICAL FIELD

The present invention relates to an organic electroluminescence element incorporating an emission layer between an anode and a cathode, and more specifically to an organic electroluminescence element exhibiting high emission efficiency and suitable for white light emission.

### BACKGROUND

Since an organic EL element (hereinafter, refers to an organic electroluminescence element) exhibits excellent visual recognition and is capable of operating at a low voltage of a few to several tens of volts due to being a self-emission type, it is possible to reduce its weight including the operating circuit thereof. Consequently, an organic EL element has been anticipated to be usable as a thin film-type display device, a lighting device, and a backlight device.

Further, an organic EL element is characterized by exhibiting extensive color variations, and is also characterized by emitting light of various colors by color mixing as combinations of plural emission colors.

Of the emission colors, in particular, white color emission is highly demanded, which may also be utilized as a backlight for a display device. Further, white color emission is separable into blue, green, and red pixels using appropriate color filters.

As such a method for emitting white light, the following two methods are applicable.

Method 1: Plural light emission compounds are doped in one emission layer.

Method 2: Plural emission colors, from plural emission layers, are combined.

For example, in cases in which white color is formed using the three colors of blue (B), green (G), and red (R), with respect to method 1, a four-source deposition for B, G, and R light emitting materials as well as for an emission host compound is required when a vacuum deposition method is employed as an emission element preparation method. Further, although there is a method of coating B, G, and R light emitting materials as well as an emission host compound after dissolving the same in a solvent or dispersing the same, there has, so far, been a continuing problem that a coating type organic EL element is inferior to a deposition type organic EL element in terms of layer durability.

On the other hand, a method of combining plural emission layers, described in method 2, has been proposed. In cases when utilizing the deposition type, method 2 is more readily employed than method 1.

With respect to such an organic EL element emitting white light, an attempt to obtain white light emission by color mixing using both of the following emission layers has been proposed, wherein the emission layers are formed by lamination of appropriate layers, which contain a blue emission layer for short wavelength emission and an yellow emission layer for long wavelength emission (refer, for example, to Patent Document 1).

Further, it has been disclosed that white light emission is obtainable by laminating three emission layers emitting B, G, and R light as a method of obtaining white light on the grounds that a high efficiency organic EL element is obtained using an orthometalated complex as a light emitting material (refer, for example, to Patent Document 2).

Further, a method has been disclosed, wherein the film thickness of an emission layer and the ratio of an organic host compound to a fluorescent compound are designed based on emission efficiency as one parameter in a laminated layer structure of at least two layers, in which, of these layers, an emission layer exhibiting lower emission efficiency (that is, a blue emission layer) is utilized on the electrode side (refer, for example, to Patent Document 3).

However, as described above, when a blue emission layer emitting the shortest wavelength light is laminated on the most outer side of an emission layer, there occurs energy transfer to the positive hole transport layer or the electron transport layer exhibiting a small band gap, resulting in a decrease in emission efficiency.

To prevent energy transfer from an emission layer, it has been proposed that a material, for example, having a wider band gap than that of the emission layer is provided as a carrier inhibition layer (refer, for example, to Non-Patent Document 1).

However, there are so far few carrier inhibition layer materials exhibiting excellent performance to prevent energy transfer even in a material having a wide band gap such as a blue light emitting material, and further there has been a problem that a material having a wide band gap generally exhibits poor durability due to its inherent properties.

Further, in cases in which an emission dopant is a phosphorescence light emitting material, a material having a wider band gap than that of a fluorescence light emitting material is required, but there are not many materials which exhibit such a property.

Further, there has been disclosed that in an organic EL element, which is allowed to emit mixed lights from its plural emission layers exhibiting different peak wavelengths, an organic EL element, having at least three layers formed by alternately laminating an emission layer for relatively short wavelength emission and an emission layer for relatively long wavelength emission, is employed as a method with the aim to inhibit chromaticity changes as much as possible due to long operating duration or voltage variation (refer, for example, to Patent Document 4).

However, although it is possible to inhibit chromaticity changes, high efficiency has not been attained because an emission dopant is a fluorescence light emitting material.

Patent Document 1: Japanese Patent Publication Open to Public Inspection (hereinafter referred to as JP-A) No. 2003-347051

Patent Document 2: JP-A No. 2001-319780

Patent Document 3: JP-A No. 2004-63349

Patent Document 4: JP-A No. 2003-187977

Non-Patent Document 1: Moon-Jae Youn. Og, Tetsuo Tsutsui et al., The 10th International Workshop on Inorganic and Organic Electroluminescence (EL '00, Hamamatsu)

### DISCLOSURE OF THE INVENTION

### Problems to be Solved by the Invention

An object of the present invention is to provide an organic electroluminescence element exhibiting high light emission efficiency.

### Means to Solve the Problems

The above-cited problems have been overcome via the following constitutions.

1. In an organic electroluminescence element incorporating a substrate having thereon an anode, a cathode, and an emission unit between the anode and the cathode, the organic electroluminescence element is characterized by having a structure in which the emission unit incorporates at least three emission layers, provided that at least two of the emission layers have different emission peaks, and among the emission layers incorporated in the emission unit, the emission layer having a shortest wavelength emission peak is sandwiched between the emission layers each having a longer wavelength emission peak.
2. The organic electroluminescence element described in 1, wherein, among the emission layers having different emission peaks, at least one of the emission layers contains a phosphorescent compound.
3. The organic electroluminescence element described in 1 or 2, wherein, among the emission layers having different emission peaks, at least two of the emission layers contain a phosphorescent compound.
4. The organic electroluminescence element described in any one of 1-3, wherein all of the emission layers having different emission peaks contain a phosphorescent compound.
5. The organic electroluminescence element described in any one of 1-4, characterized by having at least one intermediate layer containing no emission dopant being placed between the emission layers incorporated in the emission unit, wherein all of the emission layers having different emission peaks contain an emission dopant and an emission host compound.
6. The organic electroluminescence element described in any one of 1-4, wherein all of the emission layers having different emission peaks contain an emission dopant and an emission host compound, and at least one pair of two adjacent emission layers in the emission unit contains the same emission host compound.
7. The organic electroluminescence element described in any one of 1-4, wherein all of the emission layers having different emission peaks contain the same emission host compound.
8. The organic electroluminescence element described in 7, wherein all of the emission layers having different emission peaks contain an emission dopant and an emission host compound, and at least two of the emission layers having different emission peaks are adjacent emission layers, in which at least one of the interfaces in the adjacent emission layers contains emission dopants contained in each of two adjacent emission layers.
9. The organic electroluminescence element described in 8, wherein, in all of the emission layers in the emission unit, each of the emission layers contains at least two emission dopants, and an interface of the emission layers has a sloped region of the emission dopant, in which a content ratio of the emission dopants continuously varies.
10. The organic electroluminescence element described in any one of 1-9, wherein the organic electroluminescence element emits a white light.
11. The organic electroluminescence element described in any one of 1-10, wherein the emission peaks of two emission layers, sandwiching the emission layer having a shortest wavelength emission peak, are different.
12. The organic electroluminescence element described in any one of 1-10, wherein the emission peaks of two emission layers, sandwiching the emission layer having a shortest wavelength emission peak, are the same.
13. The organic electroluminescence element, described in any one of 1-5 and 10-12, wherein the difference between ionization potentials IpD and IpH is less than 0.5 eV in regard to an emission dopant and an emission host compound, respectively, contained in an emission layer having a longer wavelength emission peak, which is placed closer to the anode side than the emission layer having a shortest wavelength emission peak.
14. The organic electroluminescence element described in any one of 1-5 and 10-12, wherein the difference between the electron affinities EaD and EaH is less than 0.5 eV in regard to an emission dopant and an emission host compound, respectively, contained in an emission layer of a longer wavelength emission peak, which is placed closer to the cathode side than the emission layer having a shortest wavelength emission peak.
15. The organic electroluminescence element described in any one of 1-14, wherein when the film thickness of the emission layer having a shortest wavelength emission peak is d1, and when the film thickness of one of the emission layers having a longer wavelength emission peak and sandwiching the emission layer having a shortest wavelength emission peak is d2, d1 and d2 satisfy the following relationship: d1/d2≧5.
16. An image display device using the organic electroluminescence element described in any one of 1-15.
17. A lighting device using the organic electroluminescence element described in any one of 1-15.

### EFFECTS OF THE INVENTION

According to the constitution of the present invention, an organic electroluminescence element exhibiting high light emission efficiency has thus been provided.

### BRIEF DESCRIPTION OF THE DRAWINGS

FIG. 1 is a view of the fundamental layer constitution of the present invention.

FIG. 2 is a schematic view of a deposition apparatus incorporating deposition boats for plural emission host compounds and for plural emission dopants.

FIG. 3 is a figure showing an emission unit having mixture regions, each containing two kinds of emission dopants, in interfaces between two kinds of adjacent emission layers, and showing the dopant concentration ratios in cases in which the mixture regions are formed, as described in Example 3.

FIG. 4 is a figure showing an emission unit having slope regions, in which the content ratios of emission dopants gradually vary, wherein all of the layers in the emission unit each contains at least two kinds of emission dopants, as well as showing the dopant concentration ratios in cases in which the entire emission layer is of a slope region, as described in Example 4.

FIG. 5 is a schematic view of an example of an image display device incorporating an organic EL element.

FIG. 6 is a schematic view of a display section.

FIG. 7 is a schematic view of pixels.

FIG. 8 is a schematic view of a passive-matrix type full-color display device.

### DESCRIPTION OF ALPHANUMERIC DESIGNATIONS

1 display
3 pixel
5 scanning line
6 data line
7 electrical power line
10 organic EL element
11 switching transistor
12 operating transistor
13 capacitor
21 shutter
22 deposition boat
23 support substrate
A display section
B control section

### BEST MODES FOR CARRYING OUT THE INVENTION

A layer constitution of an organic electroluminescence element (namely an organic EL element) of the present invention is described; however the present invention is not limited thereto.

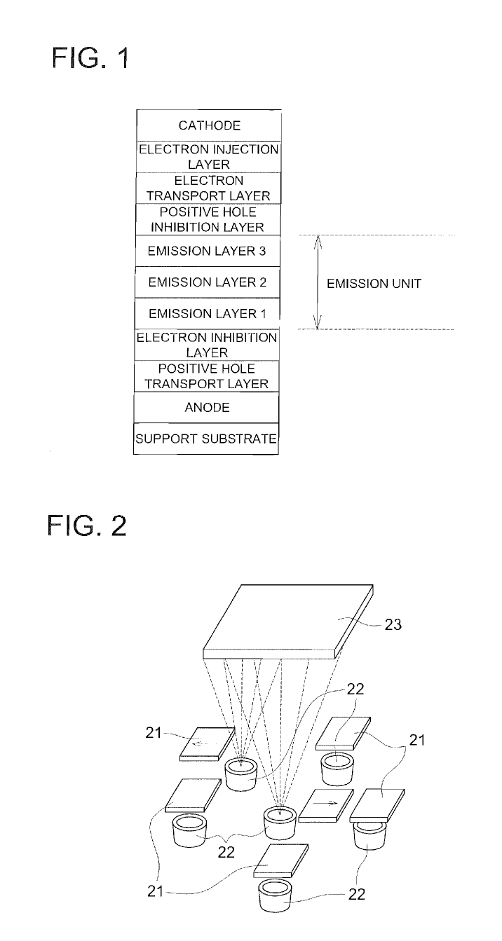

The structure, shown in element constitution 1 of FIG. 1, incorporates an emission unit between an anode and a cathode as well as a positive hole transport layer and an electron transport layer, which are placed in such a manner as to sandwich the emission unit. Appropriate substances known in the art are applicable to the positive hole transport layer and the electron transport layer. From the viewpoint of operating voltage reduction, it is preferable to utilize substances exhibiting high conductivity.

According to the present invention, an emission unit ranges from an emission layer placed closest to the cathode side to an emission layer placed closest to the anode side in an organic electroluminescence element (for example, in FIG. 1, the emission layer incorporates Emission layers 1, 2, and 3).

According to the present invention, an emission unit incorporates at least three layers, and contains at least two kinds of emission layers of different emission peaks, but said unit preferably contains two or three kinds of the aforesaid emission layers, and most preferably three kinds thereof.

According to the present invention, the emission layers of different emission peaks are those which exhibit the difference of at least 10 nm in their maximum emission wavelengths, when the emission peaks are taken via PL measurements.

Herein, the PL measurements are capable of determining a maximum emission wavelength as follows: A deposition layer is prepared on a quartz substrate using a composition of an emission dopant and an emission host compound in an emission layer, or a thin film is prepared by spin-coating or dipping in regard to a polymer prepared by a wet process, after which emission from the obtained deposition layer or from the obtained thin film is measured using a fluorescence photometer to determine the maximum emission wavelength.

According to the present invention, a structure is characterized in that an emission layer of the shortest wavelength emission peak (also referred to as a short wavelength emission layer) is sandwiched between emission layers of longer wavelength emission peaks (also referred to as long wavelength emission layers).

According to this constitution, even if energy leaks from the short wavelength emission layer, the long wavelength emission layers, sandwiching the short wavelength emission layer, emit light by trapping the leaked energy. Therefore, energy transfer from the short wavelength emission layer to any place other than the emission layers is prevented, resulting in preventing any decrease in emission efficiency of the entire emission layer.

Further, higher efficiency may be ensured using a phosphorescence emission compound as an emission dopant in these emission layers.

All of the emission layers in an emission unit of the present invention contain an emission host and an emission dopant, but according to the present invention, it is preferable that an intermediate layer, containing no emission dopant (also referred to as a non-emitting intermediate layer), be placed between two emission layers of different emission peaks in the emission unit, whereby energy transfer from a short wavelength emission layer may be better controlled. Any appropriate substances known in the art are applicable to be used in the intermediate layer.

According to the present invention, it is preferable that two adjacent emission layers in an emission unit be constituted of the same emission host compound, and further that all of the emission layers are constituted of the same emission host compound. By using the same emission host compound in the emission layers, interlayer adhesion tends to be improved, and the carrier injection barrier between different layers is reduced. In addition, the operating voltage may be lowered. The same effects, as described above, may be obtained in a mixture, as well as in a slope layer.

Colors of light emitted by activating an organic EL of the present invention are not limited, but white color is preferable.

According to the present invention, the emission peaks of two emission layers, sandwiching an emission layer of the shortest wavelength emission peak, may be identical.

For example, in cases in which a three-layered emission layer contains two kinds of emission layers of different emission peaks, it is preferable to obtain white light by combining emission layers emitting blue and yellow light, blue and orange light, or blue green and red light, wherein both sides of a layer emitting blue or blue green light, being of a short wavelength, placed in the center are sandwiched between long wavelength emission layers in such combinations as yellow, blue, and yellow light, orange, blue, and orange light, or red, blue green, and red light.

Further, according to the present invention, the emission peaks of each of two emission layers, sandwiching an emission layer of the shortest wavelength emission peak, may differ.

For example, in cases in which a three-layered emission layer is constituted, containing three kinds of emission layers of different emission peaks, it is preferable to obtain white light by combining emission layers emitting blue, green, and red light, wherein an emission layer of the shortest wavelength emission peak is sandwiched between emission layers of longer wavelength emission peaks by laminating the emission layers in the order of green, blue, and red light, or red, blue, and green light.

Consequently, it is possible to apply such a structure to various light sources for lighting or backlighting devices.

Further, colors of emitted light are not limited to white color.

It is possible to carry out delicate color adjustment by emitting light of a single color (for example, blue, green or red color) using plural emission layers of different emission peaks.

The total film thickness of an emission unit is not specifically limited, but is preferably in the range of 5-100 nm, more preferably 7-50 nm, but most preferably 10-40 nm.

In plural emission layers constituting an emission unit, when the film thickness of an emission layer of the shortest wavelength emission peak is d1, and the film thickness of an emission layer of a longer wavelength emission peak is d2, it is preferable that d1/d2≧5. This prevents the longer wavelength emission layer from becoming an energy trap, facilitating energy transfer from the longer wavelength emission layer to the shorter wavelength emission layer.

Similarly, by allowing the difference between the ionization potentials IpD and IpH of an emission dopant and an emission host compound, respectively, contained in an emission layer of a longer wavelength emission peak placed closer to the anode side than the aforesaid emission layer of a short emission peak, to be less than 0.5 eV; and by allowing the difference between the electron affinities EaD and EaH of the emission dopant and the emission host compound, respectively, contained in the emission layer of a longer wavelength emission peak placed closer to the anode side than the aforesaid emission layer of the short wavelength emission peak, to be less than 0.5 eV, the following results are obtained: positive holes injected from the anode side, or electrons injected from the cathode side become readily transferable from HOMO or LUMO in a long wavelength emission dopant to HOMO or LUMO in an emission host compound, facilitating energy transfer from the longer wavelength emission layer to the shorter wavelength emission layer.

### <Emission Dopants>

The mixture ratio of an emission dopant to an emission host compound, being the main component in an emission layer, is preferably in the range of 0.1—less than 30% by weight.

However, according to the present invention, it is preferable to utilize a phosphorescent compound (namely a phosphorescent dopant) in at least one of the layers. The emission dopant may be either a mixture of plural kinds of compounds or a phosphorescent dopant having a metal complex structure.

Emission dopants are divided into roughly two kinds: a fluorescent dopant emitting fluorescence and a phosphorescent dopant emitting phosphorescence.

Typical examples of a fluorescent dopant include coumarin type dye, pyran type dye, cyanine type dye, croconium type dye, squarylium type dye, oxobenzanthracene type dye, fluorescein type dye, rhodamine type dye, pyrylium type dye, perylene type dye, stilbene type dye, polythiophene type dye, or rare earth complex type fluorescent substances.

A typical example of a phosphorescent dopant is preferably a metal complex-type compound of the 8th, 9th, and 10th groups of the Periodic Table, being more preferably an iridium compound or an osmium compound, of which the iridium compound is most preferable.

Specific examples of a phosphorescent dopant include compounds described in the following patent publications:

WO 00/70655 pamphlet; JP-A Nos. 2002-280178, 2001-181616, 2002-280179, 2001-181617, 2002-280180, 2001-247859, 2002-299060, 2001-313178, 2002-302671, 2001-345183, and 2002-324679; WO 02/15645 pamphlet; JP-A Nos. 2002-332291, 2002-50484, 2002-332292, and 2002-83684; Japanese Translation of PCT International Application Publication No. 2002-540572; JP-A Nos. 2002-117978, 2002-338588, 2002-170684, and 2002-352960; WO 01/93642 pamphlet; JP-A Nos. 2002-50483, 2002-100476, 2002-173674, 2002-359082, 2002-175884, 2002-363552, 2002-184582, and 2003-7469; Japanese Translation of PCT International Application Publication No. 2002-525808; JP-A 2003-7471; Japanese Translation of PCT International Application Publication No. 2002-525833; and JP-A Nos. 2003-31366, 2002-226495, 2002-234894, 2002-235076, 2002-241751, 2001-319779, 2001-319780, 2002-62824, 2002-100474, 2002-203679, 2002-343572, and 2002-203678.

Some of the examples thereof are listed below.

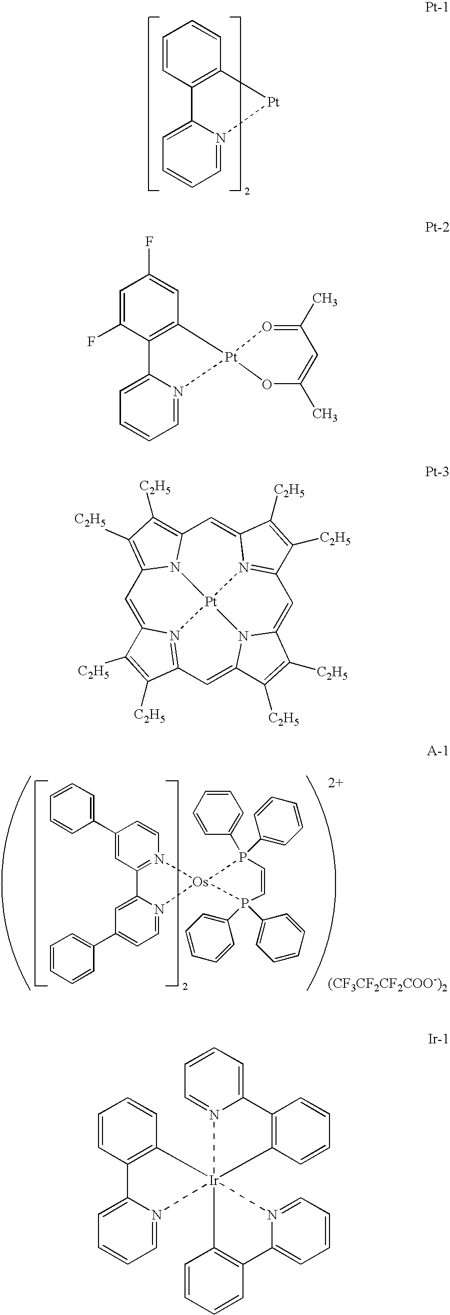

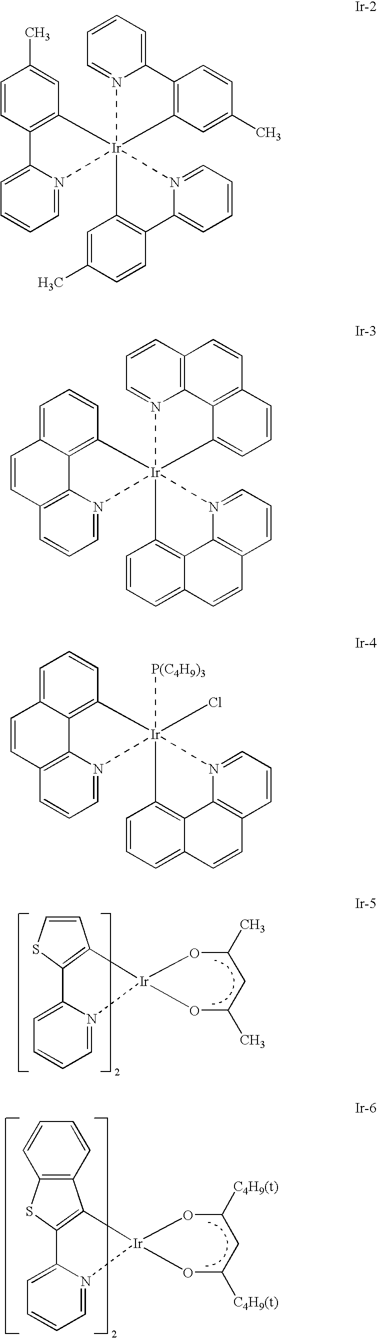

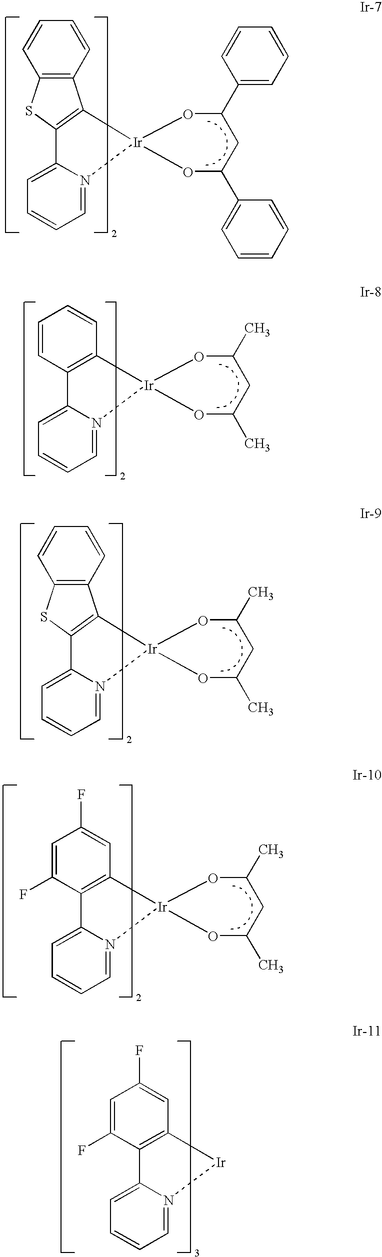

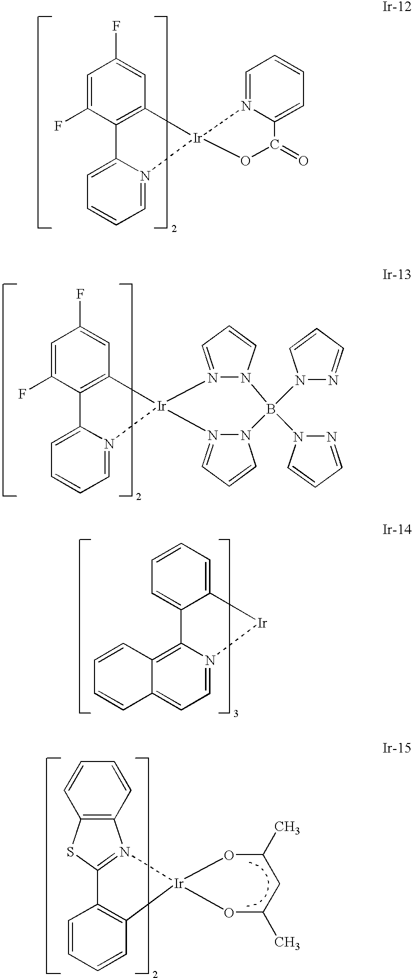

### <Emission Host Compounds>

An emission host compound, as employed in the present invention, is a compound which results in a phosphorescent quantum yield of less than 0.01 during phosphorescence emission at room temperature (25° C.).

The structure of the emission host compound, employed in the present invention, is not specifically limited. Typical compounds include carbazole derivatives, triarylamine derivatives, aromatic borane derivatives, nitrogen-containing heterocyclic compounds, thiophene derivatives, furan derivatives, and those having a basic skeleton in oligoarylene compounds, or carboline derivatives and diazacarbazole derivatives (diazacarbazole derivatives refer to carboline derivatives having a carboline ring, in which at least one of the carbon atoms in a hydrocarbon ring, constituting the aforesaid carboline ring, is substituted with a nitrogen atom).

Of these, the carboline and the diazacarbazole derivatives are preferably employed.

Specific examples of the carboline derivatives, the diazacarbazole derivatives, and the carbazole derivatives will now be listed; however, the present invention is not limited thereto.

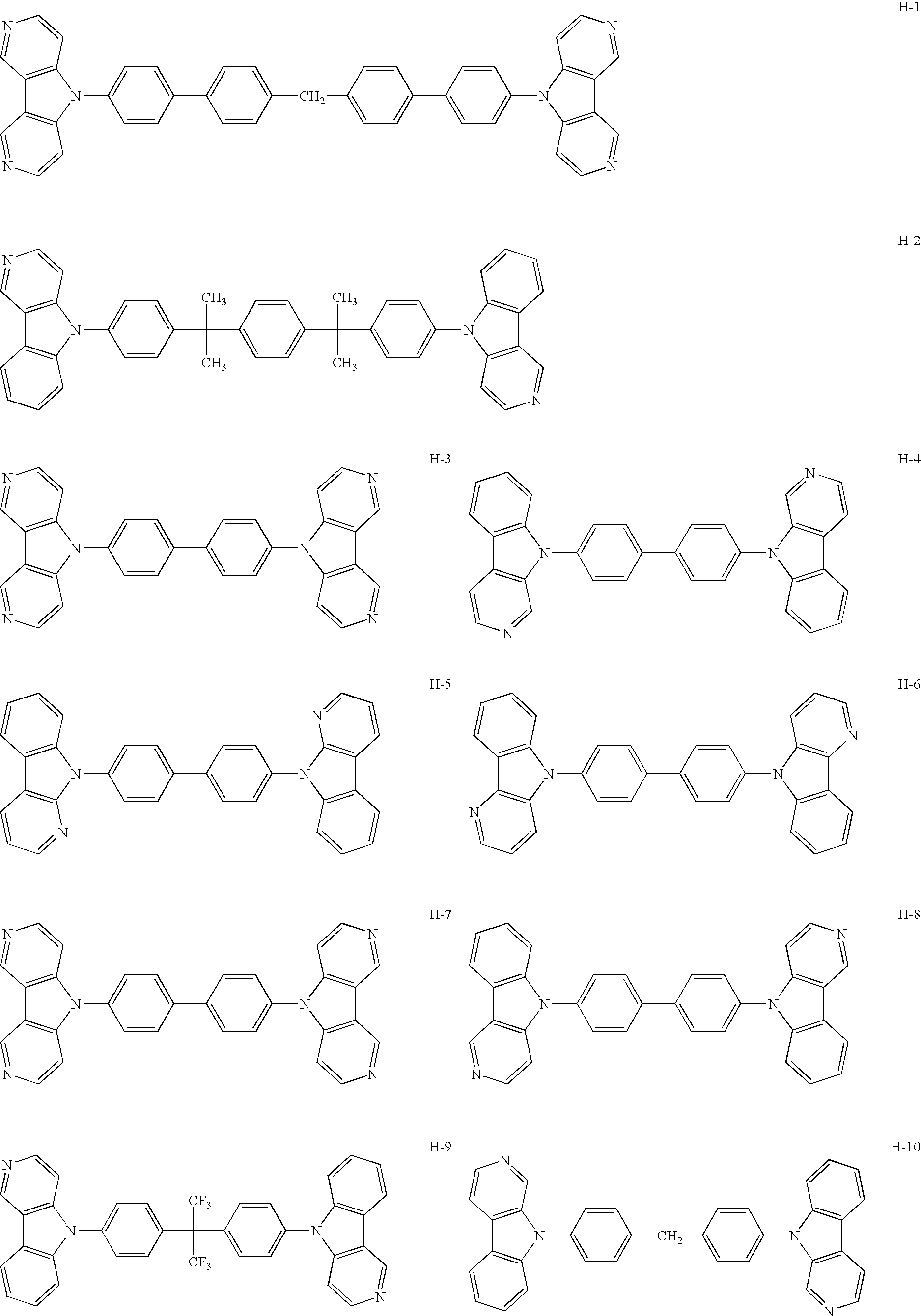

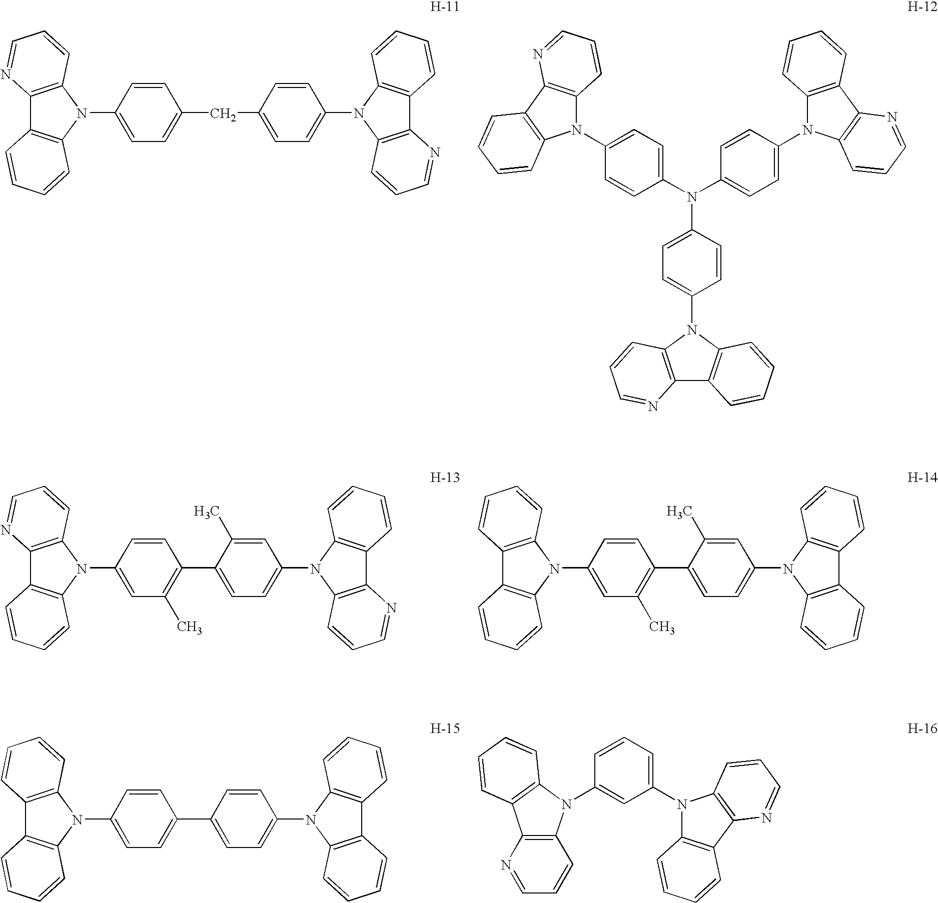

Further, an emission host utilized in the present invention may be either a low molecular weight compound or a polymer compound having a repeating unit, in addition to a low molecular weight compound having a polymerizable group such as a vinyl group or an epoxy group (being a deposition polymerizable emission host).

The emission host is preferably a compound having a positive hole transporting capability and an electron transporting capability, as well as being able to prevent elongation of an emission wavelength and exhibiting a high Tg (glass transition temperature).

As specific examples of the emission host, compounds described in the following documents are preferred: JP-A Nos. 2001-257076, 2002-308855, 2001-313179, 2002-319491, 2001-357977, 2002-334786, 2002-8860, 2002-334787, 2002-15871, 2002-334788, 2002-43056, 2002-334789, 2002-75645, 2002-338579, 2002-105445, 2002-343568, 2002-141173, 2002-352957, 2002-203683, 2002-363227, 2002-231453, 2003-3165, 2002-234888, 2003-27048, 2002-255934, 2002-260861, 2002-280183, 2002-299060, 2002-302516, 2002-305083, 2002-305084, and 2002-308837.

Next, other constituent layers usable in an organic EL element of the present invention will now be described.

### <Positive Hole Inhibition Layer>

A positive hole inhibition layer is, in the broad sense, provided with a function as an electron transport layer, being composed of a material functioning to transport electrons, but having a markedly reduced capability to transport positive holes, and enables the recombination probability of electrons and positive holes to increase by inhibiting the positive holes while transporting the electrons.

With respect to the positive hole inhibition layer, for example, a positive inhibition (hole-blocking) layer, described in JP-A Nos. 11-204258 and 11-204359 as well as on page 273 of “Organic EL Elements and Industrialization Front Thereof” (Nov. 30, 1998, published by NTS Inc.), is applicable as the positive hole inhibition layer of the present invention. Further, a constitution of an electron transport layer, as described below, may be applied to the positive hole inhibition layer, if appropriate.

### <Electron Inhibition Layer>

On the other hand, an electron inhibition layer is, in the broad sense, provided with a function as a positive hole transport layer, being composed of a material functioning to transport positive holes, but having a markedly reduced capability to transport electrons, and enables the recombination probability of electrons and positive holes to increase by inhibiting the electrons while transporting the positive holes. Further, a constitution of a positive hole transport layer, described below, may be applied to the electron inhibition layer, if appropriate.

The film thickness of a positive hole inhibition layer and an electron inhibition layer of the present invention is preferably in the range of 3-100 nm, but being more preferably in the range of 5-30 nm.

### <Positive Hole Transport Layer>

A positive hole transport layer contains a material functioning to transport positive holes, and, in the broad sense, also includes a positive hole injection layer and an electron inhibition layer. A single layer or plural layers of the positive hole transport layer may be provided.

Positive hole transport materials are not specifically limited. It is possible to employ any appropriate material selected from those which are commonly used as a charge injection and transport material for positive holes in the conventional photoconductive material area, and to employ any material from those known in the art which are used in a positive hole injection layer and a positive hole transport layer of an EL element.

A positive hole transport material is one exhibiting any one of positive hole injection or transport properties and electron barrier properties, and may be either an organic substance or an inorganic substance. For example, listed are a triazole derivative, an oxadiazole derivative, an imidazole derivative, a polyarylalkane derivative, a pyrazoline and pyrazolone derivative, a phenylenediamine derivative, an arylamine derivative, an amino-substituted chalcone derivative, an oxazole derivative, a stilylanthracene derivative, a fluorenone derivative, a hydrazone derivative, a stilbene derivative, and a silazane derivative, as well as an aniline type copolymer, and a conductive polymer oligomer. It is specifically preferable to utilize an aromatic tertiary amine compound.

As a positive hole transport material, those described above may be utilized. However, it is preferable to utilize a porphyrin compound, an aromatic tertiary amine compound, or a styrylamine compound, of which the aromatic tertiary amine compound is specifically preferable.

Typical examples of the aromatic tertiary amine compound and the styrylamine compound include N,N,N′,N′-tetraphenyl-4,4′-diaminophenyl; N,N′-diphenyl-N,N′-bis(3-methylphenyl)-(1,1′-biphenyl)-4,4′-diamine (TDP); 2,2-bis(4-di-p-tolylaminophenyl)propane; 1,1-bis(4-di-p-tolylaminophenyl)cyclohexane; N,N,N′,N′-tetra-p-tolyl-4,4′-diaminobiphenyl; 1,1-bis(4-di-p-tolylaminophenyl)-4-phenylcyclohexane; bis(4-dimethylamino-2-methyl)phenylmethane; bis(4-di-p-tolylaminophenyl)phenylmethane; N,N′-diphenyl-N,N′-di(4-methoxyphenyl)-4,4′-diaminobiphenyl; N,N,N′,N′-tetraphenyl-4,4′-diaminophenylether; 4,4′-bis(diphenylamino)quardriphenyl; N,N,N-tri(p-tolyl)amine; 4-(di-p-tolylamino)-4′-[4-(di-p-tolylamino)styryl]stilbene; 4-N,N-diphenylamino-(2-diphenylvinyl)benzene; 3-methoxy-4′-N,N-diphenylaminostilbene; and N-phenylcarbazole, in addition to those having two condensed aromatic rings in a molecule, described in U.S. Pat. No. 5,061,569, such as 4,4′-bis[N-(1-naphthyl)-N-phenylamino]biphenyl (NDP) and 4,4′,4″-tris[N-(3-methylphenyl)-N-phenylamino]triphenylamine (MTDATA), in which three of its triphenylamine unit are bonded in a starburst form, described in JP-A No. 4-308688.

Further utilized may be polymer substances, wherein the aforesaid materials are introduced in the polymer chain of the substances, or said materials form the polymer main chain thereof.

Still further, an inorganic compound such as a p-type Si and a p-type SiC may be utilized as a positive hole injection material and a positive hole transport material. Further, the positive hole transport material preferably exhibits a high Tg.

This positive hole transport layer may be prepared by forming a thin film, made of the above positive hole transport material, via a method known in the art such as the vacuum deposition method, the spin-coating method, the casting method, the ink-jet method, or the LB method. The film thickness of the positive hole transport layer is not specifically limited; however, in general, the film thickness is roughly in the range of 5-5,000 nm. This positive hole transport layer may have a single layer structure composed of one or at least two kinds of the above materials.

Further, it is also possible to utilize an impurity-doped positive hole transport layer exhibiting high p-characteristics. Examples thereof include those, which are described in JP-A Nos. 4-297076, 2000-196140, and 2001-102175, as well as J. Appl. Phys., 95, 5773 (2004).

### <Electron Transport Layer>

An electron transfer layer is composed of a material functioning to transport electrons, also including, in the broad sense, an electron injection layer and a positive hole inhibition layer. The electron transfer layer may be composed of a single layer or plural layers.

Conventionally, with respect to an electron transport material (also used as a positive hole inhibition material), utilized in a single-layered electron transfer layer and in an electron transport layer adjacent to the cathode side, compared to an emission layer in a plural-layered electron transport layer, the following materials are known.

Further, it is possible to utilize, as the electron transport layer, any layer if the layer only functions to transmit electrons injected from a cathode to an emission layer. Any material selected from those, which are known in the art, may be utilized as a material for the aforesaid purpose.

Examples of a material utilized in this electron transport layer (hereinafter, referred to as an electron transport material) include a nitro-substituted fluorene derivative, a diphenylquinone derivative, a thiopyrandioxide derivative, a heterocyclic tetracarbonic acid anhydride such as naphthaleneperylene, carbodiimide, a fluorenylidenemethane derivative, anthraquinodimethane and an anthrone derivative, and an oxadiazole derivative. Further, a thiazole derivative, in which an oxygen atom in the oxadiazole ring of the aforesaid oxadiazole derivative is substituted by a sulfur atom, and a quinoxaline derivative having a quinoxaline ring known as an electron-withdrawing group may be utilized as an electron transport material.

Further, utilized may be polymer substances, wherein these materials are introduced in the polymer chain of the substances, or said materials form the polymer main chain thereof.

Further, it is possible to use, as the electron transport material, a metal complex of a 8-quinolinol derivative such as tris(8-quinolinol)aluminum (Alq₃), tris(5,7-dichloro-8-quinolinol)aluminum, tris(5,7-dibromo-8-quinolinol)aluminum, tris(2-methyl-8-quinolinol)aluminum, tris(5-methyl-8-quinolinol)aluminum, or bis(8-quinolinol)zinc (Znq); and a metal complex in which a central metal thereof is substituted by In, Mg, Cu, Ca, Sn, Ga, or Pb. Further, metal-free or metal phthalocyanine, or those in which the terminal is substituted by an alkyl group or a sulfonic acid group are preferably utilized as the electron transport material. Further, a distyrylpyradine derivative, which has been exemplified as a material for an emission layer, may be utilized as the electron transfer material. Still further, in the same manner as for the positive hole injection layer and the positive hole transport layer, an inorganic semiconductor such as an n-type Si and an n-type SiC may also be utilized as the electron transfer material.

Said electron transport layer may be prepared by forming a thin film made of the above electron transport material, via a method known in the art such as the vacuum deposition method, the spin-coating method, the casting method, the ink-jet method or the LB method. The film thickness of the electron transport layer is not specifically limited; however, the film thickness is commonly in a rough range of 5-5,000 nm. This electron transport layer may have a single layer structure containing one or at least two kinds of the above materials.

Further, an impurity-doped electron transport layer exhibiting high p-characteristics may be utilized. Examples thereof include those, which are described in JP-A Nos. 4-297076, 2000-196140, and 2001-102175, as well as J. Appl. Phys., 95, 5773 (2004).

### <Injection Layer>: Electron Injection Layer, Positive Hole Injection Layer

An injection layer is provided, as appropriate, incorporating an electron injection layer and a positive hole injection layer. The injection layer may be placed between an anode and an emission layer or a positive transport layer, as well as between a cathode and an emission layer or an electron transport layer, as described above.

An injection layer is one which is placed between an electrode and an organic layer to reduce operating voltage and to increase emission luminance, being detailed in “Electrode Materials” (pp. 123-166) in Chapter 2 of Volume 2 of “Organic EL Elements and Industrialization Front thereof” (Nov. 30, 1998, published by NTS Inc.). The injection layer includes a positive hole injection layer (being an anode buffer layer) and an electron injection layer (being a cathode buffer layer).

An anode buffer layer (namely a positive hole injection layer) is also detailed in JP-A Nos. 9-45479, 9-260062, and 8-288069. Specific examples thereof include a phthalocyanine buffer layer such as a copper phthalocyanine buffer layer, an oxide buffer layer such as a vanadium oxide buffer layer, an amorphous carbon buffer layer, and a polymer buffer layer incorporating a conductive polymer such as polyaniline (emeraldine) or polythiophene.

A cathode buffer layer (namely an electron injection layer) is also detailed in JP-A Nos. 6-325871, 9-17574, and 10-74586. Specific examples thereof include a metal buffer layer such as a strontium or an aluminum buffer layer, an alkali metal compound buffer layer such as a lithium fluoride buffer layer, an alkaline earth metal compound buffer layer such as a magnesium fluoride buffer layer, and an oxide buffer layer such as an aluminum oxide buffer layer.

The above buffer layer (namely the injection layer) is preferably a very thin film, and the film thickness is preferably in the range of 0.1-100 nm, although it depends on the raw material.

Said injection layer may be prepared by forming a thin film, made of the above material, via a method known in the art such as the vacuum deposition method, the spin-coating method, the casting method, the ink-jet method, or the LB method. The film thickness of the injection layer is not specifically limited; however, the film thickness is commonly in a rough range of 5-5,000 nm. This injection layer may be structured as a single layer composed of one or at least two kinds of the above materials.

### <Anode>

As an anode of an organic EL element of the present invention, those, which contain metal, an alloy, a conductive compound, or a mixture thereof exhibiting a large work function (at least 4 eV) as an electrode substance, are preferably utilized. Specific examples of such an electrode substance include metal such as Au and a transparent conductive material such as CuI, indium tin oxide (ITO), SnO₂, or ZnO. Further, a material such as IDIXO (In₂O₃—ZnO), capable of being transformed into an amorphous and transparent conductive film, may also be utilized. For such an anode, the electrode substance may be formed into a thin film via a method such as deposition or sputtering, followed by forming a pattern via a mask in the desired shape via photolithography. Or, in cases in which pattern accuracy is not too strictly required (at a tolerance of about at least 100 μm), a pattern may be formed via a mask in the desired shape during depositing or sputtering the above electrode substance. When emission is taken out of this anode, the transmittance is preferably set to more than 10%, and the sheet resistance as an anode is preferably at most a few hundred Ω/□. Further, although the film thickness depends on the material, it is commonly selected to be in the range of 10-1,000 nm, but preferably of 10-200 nm.

### <Cathode>

On the other hand, as a cathode of the present invention, those, which contain metal (referred to as electron-injectable metal), an alloy, a conductive compound, and a mixture thereof exhibiting a small work function (at most 4 eV) as an electrode substance, are utilized. Specific examples of such an electrode substance include sodium, a sodium-potassium alloy, magnesium, lithium, a magnesium/copper mixture, a magnesium/silver mixture, a magnesium/aluminum mixture, a magnesium/indium mixture, an aluminum/aluminum oxide (Al₂O₃) mixture, indium, a lithium/aluminum mixture and rare earth metal. Of these, from the viewpoint of electron injection properties and resistance to oxidation, preferable are a mixture of electron injectable metal and secondary metal, being stable metal exhibiting a larger work function than the electron injectable metal, such as a magnesium/silver mixture, a magnesium/aluminum mixture, a magnesium/indium mixture, an aluminum/aluminum oxide (Al₂O₃) mixture, and a lithium/aluminum mixture as well as aluminum. The cathode may be prepared by forming a thin film via a method of depositing or sputtering these electrode substances. Further, the sheet resistance as the cathode is preferably at most a few hundred Ω/□, and the film thickness is commonly selected to be in the range of 10-1,000 nm, but preferably being of 50-200 nm. In addition, to enable emission to be transmitted, it is preferable for either the anode or the cathode of an organic EL element to be transparent or translucent.

### <Substrate (Also Referred to as Base Plate, Base Material, Support, or Support Substrate)>

The substrate of an organic EL element of the present invention is not specifically limited by type such as glass or plastics, and a transparent substrate may be employed without any specific limitation. However, examples of a preferably employed substrate include glass, quartz and light-transmittable resin films. A specifically preferred substrate is a resin film capable of providing an organic EL element with flexibility.

Examples of such a resin film include a film composed of polyethylene terephthalate (PET), polyethylene naphthalate (PEN), polyether sulfone (PES), polyether imide, polyether ether ketone, polyphenylene sulfide, polyallylate, polyimide, polycarbonate (PC), cellulose triacetate (TAC), and cellulose acetate propionate (CAP).

A coating of an inorganic or an organic substance, or a hybrid coating thereof may be formed on the surface of the resin film, being preferably a high barrier film exhibiting water vapor transmittance of at most 0.01 g/m²·day·atm.

The taking out efficiency of emission of an organic EL element of the present invention at room temperature is preferably at least 1%, but more preferably at least 2%. Herein, the taking out quantum efficiency (%)=the number of photons emitted from the organic EL element/the number of electrons passing into the organic EL element×100.

In lighting applications, a rough-surfaced film (being an anti-glare film) may be utilized in combination to decrease emission nonuniformity.

### <Preparation Method of Organic EL Elements>

As an example of a preparation method of an organic EL element of the present invention, a preparation method of an organic EL element, incorporating anode/positive hole injection layer/positive hole transport layer/emission layer (of at least three layers)/positive hole inhibition layer/electron transport layer/cathode buffer layer/cathode, will be described.

Initially, an anode is prepared on an appropriate substrate by forming a thin film, incorporating a desired electrode substance such as an anode substance by means of deposition or sputtering, wherein the thin film is formed in which the film thickness is at most 1 μm, but is preferably in the range of 10-200 nm. Subsequently, a thin film is formed thereon, which contains organic substances used as element materials in a positive hole injection layer, a positive hole transport layer, an emission layer (of at least three layers), a positive hole inhibition layer, and an electron transport layer.

A production method of this thin film containing the organic substances includes the spin-coating method, the casting method, the ink-jet method, the deposition method, and the printing method. However, the vacuum deposition method or the spin-coating method is specifically preferable since a more homogeneous film is obtained and creation of pinholes is negligible. Further, a different film preparation method may be applied for each layer.

In cases when employing the deposition method in film preparation, although the deposition conditions depend on the types of compounds to be used, it is common to appropriately set the deposition conditions to be in the range of 50-450° C. for the boat heating temperature, 10⁻⁶-10⁻² Pa for a degree of vacuum, 0.01-50 nm/sec for the deposition rate, −50-300° C. for the substrate temperature, and 0.1 nm-5 μm for film thickness.

A deposition apparatus usable in the preparation method of an organic EL element of the present invention is shown in FIG. 2.

FIG. 2 is a schematic view of a deposition apparatus incorporating deposition boat 2 utilized for plural emission host compounds and plural emission dopants. An emission unit incorporating emission layers, each of different emission peaks, may be formed by controlling the heating temperature of each of deposition boats 2 as well as the opening and closing of shutter 1 attached to each of the deposition boats.

It is preferable to place an intermediate layer incorporating no emission dopant, prepared in a boat disposed within the above deposition apparatus, between two adjacent emission layers in an emission unit since a preventive effect of color shift due to voltage variation is realized.

Further, the use of the above deposition apparatus enables formation of the following constitution meeting the various objects: all the emission layers of different emission peaks contain an emission dopant and an emission host compound, and any two adjacent emission layers are composed of the same emission host compound; further, all the emission layers of different emission peaks are composed of the same emission host compound; the interface of two kinds of adjacent emission layers in an emission unit incorporates a mixture region containing two kinds of emission dopants stemming from each of the aforesaid adjacent emission layers; and all the emission layers in the emission unit incorporate slope-mixture regions, each of which contains at least two kinds of emission dopants, whose content ratio varies gradually. Thus, the effect of enabling the operating voltage to decrease has been realized.

After these layers are formed, a cathode is produced by forming a thin film incorporating a cathode electrode substance thereon, for example, by deposition or sputtering to a film thickness of at most 1 μm, but being preferably in the range of 50-200 nm, whereby a desired organic EL element is prepared. In such preparation of an organic EL element, it is preferable to carry out integrated preparation from a positive hole injection layer to a cathode by a single vacuum draw. However, a different preparation method may be applied to an intermediate product taken out during the preparation, which must be conducted under a dry inert gas ambience.

### <Display Device>

A display device of the present invention will now be described.

An image display device provided with an organic EL element of the present invention may be either monochromatic or polychromatic. In cases of a multicolor display device, a shadow mask is provided with each color emission unit. At least three emission layers for each color are formed by the casting method, the spin-coating method, the ink-jet method, or the printing method.

When patterning is performed for an emission layer, the method thereof is not specifically limited, and the deposition method, the ink-jet method, and the printing method are preferable. However, patterning via a shadow mask is preferred for the deposition method.

In cases of a monochrome display, for example, for white color, at least three emission layers are formed by applying the deposition method, the casting method, the spin-coating method, or the ink-jet method over the entire layers without patterning.

Further, by reversing the preparation order, it is possible to prepare a cathode, an electron transport layer, a positive hole inhibition layer, an emission layer (of at least three layers), a positive hole transport layer, and an anode in this stated order.

When a direct current voltage is applied to an image display device thus prepared, emission may be observed by applying a voltage of approximately 2-40 V setting the anode as positive polarity and the cathode as negative polarity. However, if voltage is applied at reversed polarity, no emission is generated at all since no current flows. Further, in cases when applying an alternate current voltage, emission is generated only in the state of an anode being positive and a cathode being negative. Herein, any wave shape of alternate current may be applied.

In cases of a white color display device, an organic EL element may be employed as a display device and a display, as well as various emission light sources. As for the display device and the display, display in full color may be realized using a white-light emitting organic EL element for backlighting.

Examples of the display device and the display include a television set, a personal computer, a mobile device, AV equipment, a teletext display, and an in-car information display. Specifically, it is also possible to utilize the organic EL element as a display device for reproducing still and moving images.

Examples of the emission light sources include household lighting, car-interior lighting, backlights for watches or liquid crystals, light sources for advertising billboards, signal systems, and optical memory media, as well as light sources for electrophotographic copiers, optical telecommunication processors, and optical sensors, without however being limited thereto.

### <Lighting Device>

A lighting device of the present invention will now be described.

An organic EL element of the present invention may be utilized as an organic EL element provided with a resonator structure, and application purposes of such an organic EL element having a resonator structure include light sources for optical memory media, electrophotographic copiers, optical telecommunication processors, and optical sensors, without however being limited thereto.

Further, an organic EL element of the present invention may be utilized as one type of lamp for such as lighting and an exposure light source, and may also be utilized as in a type of projector to project images, as well as a type of display device (display) for direct viewing of still and moving images. An operating method in cases of being utilized as a display device for reproducing moving images may be either a simple matrix (being a passive matrix) type, or an active matrix type. In addition, a full-color display device may be prepared by utilizing at least two kinds of organic EL elements of the present invention, with each element emitting light of a different color.

In cases in which an organic EL element of the present invention is utilized as a white-light emitting element, it is possible to achieve full-color display via combinations of BGR color filters.

An organic EL element of the present invention may also be applied to an organic EL element emitting light of almost pure white color as a lighting device.

An example of a display device incorporating an organic EL element of the present invention is described below by referring to drawings.

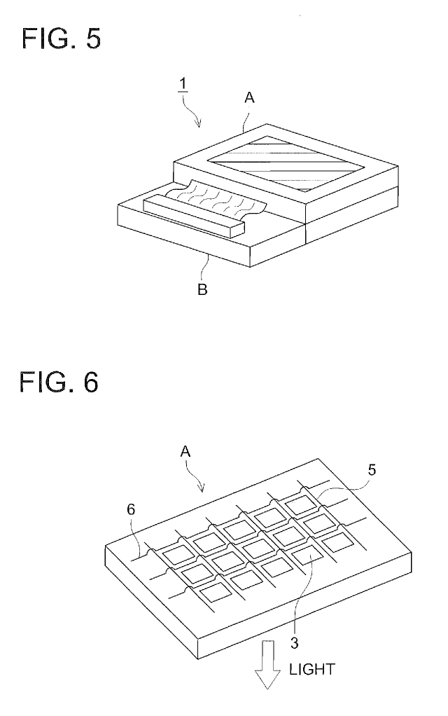

FIG. 5 is a schematic view of an example of a display device constituted of an organic EL element. Image information display is carried out vi an emission of the organic EL element. One example thereof is a schematic view of a display for a mobile phone.

Display 1 is constituted of display section A featuring plural pixels, and control section B for scanning images on display section A based on image information.

Control section B, electrically connected to display section A, sends scanning signals and image data signals based on image information from the appropriate outside to each of the plural pixels, and then pixels in each scanning line sequentially emit light according to the image data signals based on the scanning signals, whereby the image information is displayed on display section A via the aforesaid image scanning.

FIG. 6 is a schematic view of display section A.

Display section A is provided with a wiring section, which contains plural scanning lines 5 and data lines 6 as well as plural pixels 3 on a substrate. The main part constituents of display section A will now be described.

The figure shows a case in which light emitted from pixel 3 is taken out in the white arrow direction (downward).

Scanning lines 5 and plural data lines 6 in the wiring section are each composed of conductive materials, and scanning lines 5 and data lines 6 are perpendicular to each other in a grid pattern and are connected to pixels 3 at the right-angled crossing points (details of which are not shown in the figure).

Pixels 3 receive image data signals from data lines 6 when scanning signals are applied via scanning lines 5, and emit light based on received image data. Full-color display may be realized by appropriately aligning pixels emitting light in the red, the green, and the blue regions on the same substrate.

In cases in which an organic EL element of the preset invention is utilized as a white-light emitting element, full-color display may be realized via combinations of BGR color filters.

Further, the emission process of a pixel will now be described.

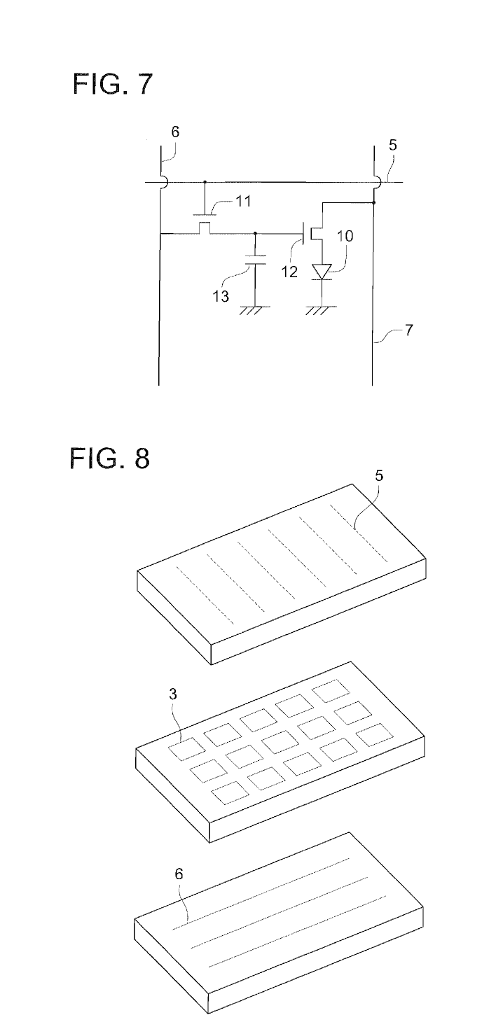

FIG. 7 is a schematic view of a pixel.

A pixel incorporates organic EL element 10, switching transistor 11, operating transistor 12 and capacitor 13. In cases in which a white light-emitting organic EL element utilized as organic EL element 10, divided into plural pixels, full-color display may be achieved via combinations of BGR color filters.

In FIG. 7, an image data signal is applied to the drain in switching transistor 11 from control section B via data line 6. Subsequently, when a scanned signal is applied to the gate in switching transistor 11 from control section B via scanning line 5, switching transistor 11 is activated, whereby the image data signal applied to the drain is transmitted to the gates in capacitor 13 and operating transistor 12.

Operating transistor 12 is activated as capacitor 13 is charged based on the potential of the image data signal via transmission of the image data signal. In operating transistor 12, the drain is connected to electric source line 7, and an electrical source is connected to an electrode of organic EL element 10, whereby electric current is supplied to organic EL element 10 from electrical source line 7 according to the potential of the image data signal applied to the gates.

When a scanned signal is transferred to next scanning line 5 via sequential scanning of control section B, switching transistor 11 is deactivated. However, since capacitor 13 retains the potential of the charged image data signal even when switching transistor 11 is deactivated, operating transistor 12 remains energized, whereby organic EL element 10 continues to emit light until the next scanned signal is applied. When the following scanned signal is applied via sequential scanning, organic EL element 10 emits light via operation of operating transistor 12 according to the potential of the next image data signal synchronizing with the scanned signal.

Thus, in cases of emission of organic EL element 10, by providing each of organic EL elements 10 for plural pixels with switching transistor 11 and operating transistor 12, being active elements, emission of each of organic EL elements 10 for plural pixels 3 is achieved. Such an emission method is referred to as an active matrix type.

Herein, emission of organic EL element 10 may be either emission of plural gradations based on multivalued image data signals of plural gradation potentials, or emission via on-off control of a predetermined emission quantity based on binary image data signals.

Further, the potential of capacitor 13 may be either kept until the next scanned signal is applied, or discharged immediately before the next scanned signal is applied.

According to the present invention, without applying only to the above active matrix type, emission may be achieved via emitting operation of a passive matrix type enabling an organic EL element to emit light based on a data signal only when a scanned signal is renewed.

FIG. 8 is a schematic view of a passive matrix type display device. Plural scanning lines 5 and plural image data lines 6 are each opposed in a grid pattern, sandwiching pixels 3.

When a scanned signal of scanning line 5 is applied via sequential scanning, pixel 3 connected to applied scanning line 5 emits light based on the image data signal. In a passive matrix type, pixel 3 incorporates no active element, resulting in reduced production cost.

With respect to a white-light emitting organic EL element of the present invention, it is also possible to employ metal masking or patterning using ink-jet printing during film preparation, as appropriate. In cases in which patterning is applied, patterning may be employed for whichever one of only an electrode, an electrode and an emission layer, or the entire element layer.

In this way, in addition to the aforesaid display device and display, a white-light emitting organic EL element of the present invention is functional as various types of emission light sources and lighting devices, and for household lighting and car-interior lighting as well as being usefully employed as a type of lamp such as an exposure light source and a display device such as a liquid crystal backlight.

In addition to these applications, others in a broad range may be exemplified as follows: watch backlight sources for advertising billboards, signal systems, and optical memory media; light sources for electrophotographic copiers, optical telecommunication processors, and optical sensors; and household electrical appliances.

### EXAMPLES

### Example 1

### Preparation of Organic EL Element 1-1

After a substrate (NA-45, produced by NH Techno Glass Corp.), which was prepared by depositing ITO (indium tin oxide) at a 100 nm thickness on a glass plate of a size of 100×100×1.1 mm serving as an anode, was subjected to patterning, the transparent support substrate having this ITO transparent anode was cleaned with isopropyl alcohol via ultrasonic waves, and dried using dry nitrogen, followed by being subjected to UV ozone cleaning for 5 minutes. This transparent support substrate was fixed onto a substrate holder in a common vacuum deposition apparatus available on the market. On the other hand, resistance heating boats, made of molybdenum, individually containing only one of the following materials, were attached to the vacuum deposition apparatus: these materials were 200 mg of copper phthalocyanine (CuPc), 200 mg of α-NPD, 200 mg of H-14, 200 mg of H-15, 100 mg of Ir-12, 100 mg of Ir-15, 200 mg of BAlq, and 200 mg of Alq₃.

Further, after the vacuum chamber was decompressed to 4×10⁻⁴ Pa, the aforesaid heating boat charged with CuPc was heated via an electrical current, whereby CuPc was deposited onto the transparent support substrate at a deposition rate of 0.1 nm/sec to form a 30 nm positive hole injection layer.

Further, the aforesaid heating boat charged with α-NPD was heated via an electrical current, whereby α-NPD was deposited onto the aforesaid positive hole injection layer at a deposition rate of 0.1 nm/sec to form a 40 nm positive hole transport layer.

Further, the aforesaid heating boats charged with H-15 and Ir-15 were heated via an electrical current, whereby yellow-emission layers 1, represented by various weight ratios and film thicknesses listed in Table 1, were formed on the aforesaid positive hole transport layer via co-deposition.

Further, the aforesaid heating boats charged with H-14 and Ir-12 were heated via an electrical current, whereby blue-emission layers 2, represented by various weight ratios and film thicknesses listed in Table 1, were formed on the aforesaid emission layers 1 via co-deposition.

Further, the aforesaid heating boats charged with H-15 and Ir-15 were heated via an electrical current, whereby yellow-emission layers 3, represented by various weight ratios and film thicknesses listed in Table 1, were formed on the aforesaid emission layers 2 via co-deposition.

Further, the aforesaid heating boat charged with BAlq was heated via an electrical current, whereby BAlq was deposited onto the aforesaid emission layer 3 at a deposition rate of 0.1 nm/sec to form a 10 nm first electron transport layer.

Further, the aforesaid heating boat charged with Alq₃ was heated via an electrical current, whereby Alq₃ was deposited onto the aforesaid first electron transport layer at a deposition rate of 0.1 nm/sec to form a 30 nm second electron transport layer.

Herein, the substrates were treated at room temperature during deposition.

Subsequently, 0.5 mg of lithium fluoride was deposited as a cathode buffer layer, and then a cathode was prepared by depositing aluminum at a thickness of up to 110 nm to prepare Organic EL Element 1-1.

### <Preparation of Organic EL Elements 1-2-1-6>

Organic EL Elements 1-2-1-6 were prepared in the same manner as for Organic EL Element 1-1 except that the constitution of the emission layers in Organic EL Element 1-1 was changed as shown in Table 1.

### <Preparation of Comparative Examples: Organic EL Elements 1-7 and 1-8>

Organic EL Elements 1-7 and 1-8 were prepared in the same manner as for Organic EL Element 1-1 except that the constitution of the emission layers in Organic EL Element 1-1 was changed as shown in Table 1.

### <Evaluation>

Each of the obtained elements was evaluated using the following method.

### (Taking-Out Quantum Efficiency)

With respect to the prepared organic EL elements, the taking-out quantum efficiency (in %) was measured at 23° C. under a dry nitrogen ambience by applying a constant current of 2.5 mA/cm². Herein, measurement was carried out using a spectroradiometer CS-1000 (produced by Konica Minolta Sensing, Inc.).

The measurement results of the taking-out quantum efficiencies listed in Table 1 are shown as relative values with respect to 100 being the value given for Organic EL Element 1-9.

Now, compounds, which are utilized to form each layer, are listed below.

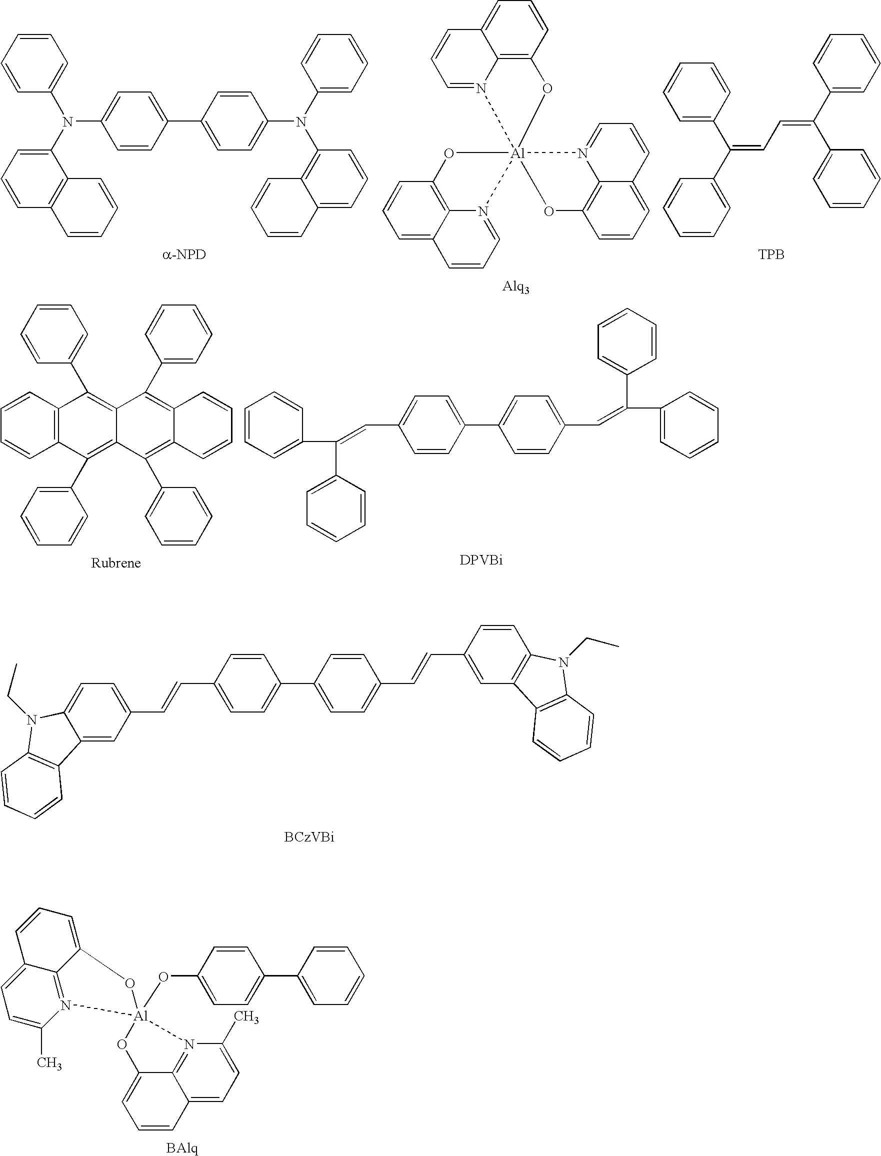

TABLE 1

| | Emission Unit | | | Taking-out | |
|---|---|---|---|---|---|
| Organic EL | Emission | Emission | Emission | Quantum | |
| Element | layer 1 | layer 2 | layer 3 | Efficiency | Remarks |
| 1-1 | H-15: Ir-15 | H-14: I-12 | H-15: Ir-15 | 145 | Present |
| | (6 weight %, | (3 weight %, | (6 weight %, | | Invention |
| | 3 nm) | 25 nm) | 5 nm) | | |
| 1-2 | H-15: Ir-15 | DPVBi: BCzVBi | H-15: Ir-15 | 110 | Present |
| | (6 weight %, | (1 weight %, | (6 weight %, | | Invention |
| | 3 nm) | 35 nm) | 7 nm) | | |
| 1-3 | H-15: Ir-9 | H-14:Ir-12 | H-15: Ir-9 | 130 | Present |
| | (8 weight %, | (3 weight %, | (8 weight %, | | Invention |
| | 3 nm) | 25 nm) | 5 nm) | | |
| 1-4 | H-15: Ir-9 | H-14: Ir-13 | H-15: Ir-1 | 132 | Present |
| | (8 weight %, | (3 weight %, | (6 weight%, | | Invention |
| | 3 nm) | 25 nm) | 5 nm) | | |
| 1-5 | H-15: Ir-1 | H-14: Ir-13 | H-15: Ir-9 | 138 | Present |
| | (6 weight %, | (3 weight %, | (8 weight %, | | Invention |
| | 4 nm) | 25 nm) | 4 nm) | | |
| 1-6 | H-16: Ir-1 | H-16: Ir-13 | H-16: Ir-9 | 140 | Present |
| | (6 weight %, | (3 weight %, | (8 weight %, | | Invention |
| | 4 nm) | 25 nm) | 4 nm) | | |
| 1-7 | DPVBi: BCzVBi | — | α-NPD: | 30 | Comparative |
| | (1 weight %, | | Rubrene | | Sample |
| | 50 nm) | | (1 weight %, | | |
| | | | 10 nm) | | |
| 1-8 | α-NPD: TPB | H-15: Ir-1 | H-15: Ir-9 | 100 | Comparative |
| | (3 weight %, | (6 weight %, | (8 weight %, | | Sample |
| | 12 nm) | 12 nm) | 12 nm) | | |

TABLE 2

| | Emission unit | | | | | |
|---|---|---|---|---|---|---|
| | Emission layer 1 | | Emission layer 2 | | Emission layer 3 | |
| | | Emis- | | Emis- | | |
| Organic | | sion | | sion | Emis- | Emission |
| EL | Emission | Wave- | Emission | Wave- | sion | Wave- |
| Element | Dopant | length | Dopant | length | Dopant | length |
| 1-1 | Ir-15 | 580 nm | Ir-12 | 470 nm | Ir-15 | 580 nm |
| 1-2 | Ir-15 | 580 nm | BCzVBi | 460 nm | Ir-15 | 580 nm |
| 1-3 | Ir-9 | 620 nm | Ir-12 | 470 nm | Ir-9 | 620 nm |
| 1-4 | Ir-9 | 620 nm | Ir-13 | 460 nm | Ir-1 | 520 nm |
| 1-5 | Ir-1 | 520 nm | Ir-13 | 460 nm | Ir-9 | 620 nm |
| 1-6 | Ir-1 | 520 nm | Ir-13 | 460 nm | Ir-9 | 620 nm |
| 1-7 | BCzVBi | 460 nm | — | | Rubrene | 560 nm |
| 1-8 | TPB | 450 nm | Irl | 520 nm | Ir-9 | 620 nm |

### Example 2

### Preparation of Organic EL Elements 2-1

Organic EL Elements 2-1-2-6 were prepared in the same manner as for Organic EL Elements 1-1-1-6 except that a 3 nm intermediate layer was formed between two adjacent emission layers via deposition in Organic EL Elements 1-1-1-6.

### <Evaluation of Chromaticity Shift>

A chromaticity shift represents a shift in chromaticity coordinates at luminances of 100 cd/m² and 5,000 cd/m² in the CIF chromaticity diagram. Herein, measurement was carried out, under a dry nitrogen ambience, using a spectroradiometer CS-1000 (produced by Konica Minolta Sensing, Inc.) at 23° C.

The measurement results are listed in following Table 3.

TABLE 3

| Organic EL | | Organic EL | |
|---|---|---|---|
| Element | | Element | |
| (without an | | (with an | |
| Intermediate | Chromaticity | Intermediate | Chromaticity |
| Layer) | Shift | Layer) | Shift |
| 1-1 | 0.03 | 2-1 | 0.008 |
| 1-2 | 0.05 | 2-2 | 0.01 |
| 1-3 | 0.042 | 2-3 | 0.009 |
| 1-4 | 0.037 | 2-4 | 0.008 |
| 1-5 | 0.02 | 2-5 | 0.002 |
| 1-6 | 0.025 | 2-6 | 0.004 |

As can be seen from the results shown in Table 3, chromaticity shifts of Organic EL Elements 2-1-2-6 were inhibited at high voltage, compared to Organic EL Elements 1-1-1-6.

### Example 3

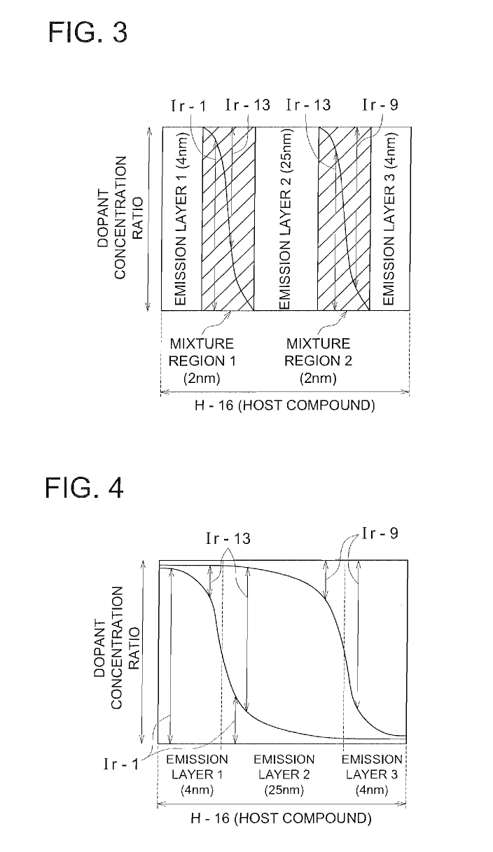

Organic EL Element 3-6 was prepared in the same manner as for Organic EL Element 1-6 except that 2 nm of mixture region 1 containing H-16, Ir-1, and Ir-13 was formed between emission layer 1 and emission layer 2, as well as 2 nm of mixture region 2 containing H-16, Ir-13, and Ir-9 was formed between emission layer 2 and emission layer 3 in an emission unit, as shown in FIG. 3, in preparation of Organic EL Element 1-6. However, in mixture region 1, the following control was carried out: the deposition rate of Ir-1 was allowed to begin to decrease at deposition initiation and to become zero when its film thickness reached 2 nm; and the deposition rate of Ir-13 was allowed to begin to increase at deposition initiation, and then the weight ratio thereof to H-16 was allowed to become the same as in emission layer 2 when the film thickness of Ir-13 reached 2 nm. Similarly, in mixture region 1, the following control was carried out: the deposition rate of Ir-13 was allowed to begin to decrease at deposition initiation and to become zero when its film thickness reached 2 nm, and the deposition rate of Ir-9 was allowed to begin to increase at deposition initiation, and then the weight ratio thereof to H-16 was allowed to become the same as in emission layer 3 when the film thickness of Ir-9 reached 2 nm.

It was confirmed that the operating voltage of Organic EL Element 3-6 was less, compared to Organic EL Element 1-6.

### Example 4

Organic EL Element 4-6 was prepared in the same manner as for Organic EL Element 1-6 except that the emission dopant concentration was allowed to vary continuously in all of the layers of an emission unit, as shown in FIG. 4, in preparation of Organic EL Element 1-6.

However, the emission layer shown in FIG. 4 was prepared as follows.

Vacuum deposition was initiated via current heating of H-16, Ir-1, Ir-13, and Ir-9 under deposition-rate control. Deposition was initiated after making preparations for allowing the weight ratio thereof to become H-16:Ir-1:Ir-13:Ir-9=93.8:6:0.1:0.1, respectively when the thickness of the emission unit was 0 nm. Deposition rates of Ir-1, Ir-13, and Ir-9 were controlled as follows: under which the deposition rate of H-16 was kept constant, the weight ratios described above were allowed to become 94.9:3:2:0.1, 92.9:0.1:2:5, and 90.8:0.1:0.1:9 when the film thicknesses reached 4 nm, 29 nm, and 33 nm, respectively.

It was confirmed that the operating voltage of Organic EL Element 4-6 was less, compared to Organic EL Element 1-6.

### Example 5

Organic EL Elements 5-1-5-6 were prepared in the same manner as for Organic EL Elements 1-1-1-6 except that CuPc and Alq₃ of Organic EL Elements 1-1-1-6 were changed to co-deposited layers incorporating m-MTDATA:F4-TCNQ (weight ratio: 99:1) and BPhen:Cs (weight ratio: 75:25), respectively, and LiF was not deposited in this case.

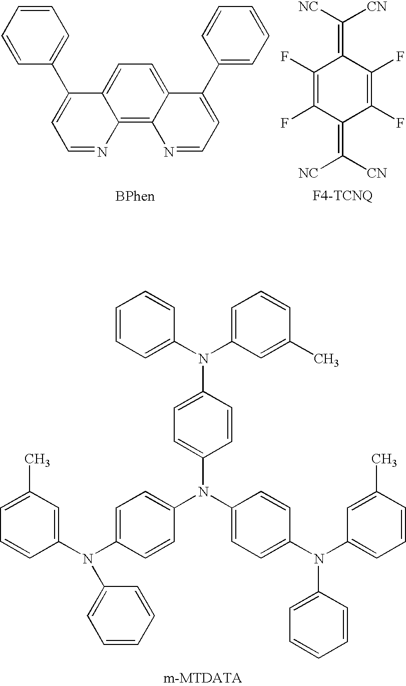

It was confirmed that each of the operating voltages of Organic EL Elements 5-1-5-6 was lowered by 3-6 V, compared to Organic EL Elements 1-1-1-6.

### Example 6

### Image Display Device Using a White-Light Emitting Organic EL Element

An image display device, prepared by covering the non-emission side of Organic EL Elements 1-7 with a glass case and by attaching a color filter to the emission side thereof, was found to exhibit preferable full-color display performance, enabling employment as an excellent image display device.

### Example 7

### Preparation of a Lighting Device Using a White-Light Emitting Organic EL Element

A lighting device was prepared by covering the non-emission side of Organic EL Elements 1-2 with a glass case. The prepared lighting device was found to be employable as a thin-type lighting device, emitting white-color light, and exhibiting high emission efficiency.

1. An organic electroluminescence element comprising a substrate having thereon an anode, a cathode, and an emission unit between the anode and the cathode,
wherein the emission unit comprises at least three emission layers, provided that at least two of the emission layers have different emission peaks, and the emission layer having a shortest wavelength emission peak is sandwiched between the emission layers each having a longer wavelength emission peak.

2. The organic electroluminescence element of claim 1,
wherein at least one of the emission layers having different emission peaks contains a phosphorescent compound.

3. The organic electroluminescence element of claim 1,
wherein at least two of the emission layers having different emission peaks contain a phosphorescent compound.

4. The organic electroluminescence element of claim 1,
wherein all of the emission layers having different emission peaks contain a phosphorescent compound.

5. The organic electroluminescence element of claim 1,
wherein all of the emission layers having different emission peaks contain an emission dopant and an emission host compound, and at least one intermediate layer containing no emission dopant is provided between the emission layers in the emission unit.

6. The organic electroluminescence element of claim 1,
wherein all of the emission layers having different emission peaks contain an emission dopant and an emission host compound, and at least one pair of two adjacent emission layers in the emission unit contains the same emission host compound.

7. The organic electroluminescence element of claim 1,
wherein all of the emission layers having different emission peaks contain the same emission host compound.

8. The organic electroluminescence element of claim 7,
wherein all of the emission layers having different emission peaks contain an emission dopant and an emission host compound, and at least two of the emission layers having different emission peaks are adjacent emission layers, in which at least one of the interfaces of the adjacent emission layers contains emission dopants contained in each of two adjacent emission layers.

9. The organic electroluminescence element of claim 8,
wherein each of the emission layers contains at least two emission dopants, and an interface of the emission layers has a sloped region of the emission dopant, in which a content ratio of the emission dopants continuously varies.

10. The organic electroluminescence element of claim 1
wherein the organic electroluminescence element emits a white light.

11. The organic electroluminescence element of claim 1,
wherein the emission peaks of two emission layers, sandwiching the emission layer having a shortest wavelength emission peak, are different.

12. The organic electroluminescence of claim 1,
wherein emission peaks of two emission layers, sandwiching the emission layer having a shortest wavelength emission peak, are the same.

13. The organic electroluminescence element of claim 1,
wherein a difference between an ionization potential of an emission dopant (IpD) and an ionization potential of an emission host compound (IpH) is less than 0.5 eV,
provided that the emission dopant and an emission host compound are contained in the emission layer having a longer wavelength emission peak and being placed closer to the anode than the emission layer having a shortest wavelength emission peak.

14. The organic electroluminescence element of claim 1,
wherein a difference between the electron affinity of an emission dopant (EaD) and an electron affinity of an emission host compound (EaH) is less than 0.5 eV,
provided that the emission dopant and the emission host compound are contained in the emission layer having a longer wavelength emission peak and being placed closer to the cathode than the emission layer having a shortest wavelength emission peak.

15. The organic electroluminescence element of claim 1,
wherein when a film thickness of the emission layer having a shortest wavelength emission peak is d1, and a film thickness of one of the emission layers having a longer wavelength emission peak and sandwiching the emission layer having a shortest wavelength emission peak is d2, d1 and d2 satisfy the following relationship: d1/d2≧5.

16. An image display device comprising organic electroluminescence element of claim 1.

17. A lighting device comprising the organic electroluminescence element of claim 1.
